(19) United States
(12) Patent Application Publication
(10) Pub. No.: US 2014/0250693 A1
(43) Pub. Date: Sep. 11, 2014

(54) ROTARY ELECTRIC SHAVING UNIT

(71) Applicant: Judi Milke, Shreveport, LA (US)

(72) Inventor: Judi Milke, Shreveport, LA (US)

(21) Appl. No.: 14/163,333

(22) Filed: Jan. 24, 2014

Related U.S. Application Data
(60) Provisional application No. 61/776,605, filed on Mar. 11, 2013.

(51) Int. Cl. B26B 19/14

(52) U.S. Cl. CPC B26B 19/14
USPC 30/43.4

(57) ABSTRACT

A ROTARY ELECTRIC SHAVING UNIT for a rotary blade shaver that comprises a shaver housing that is easily and effectively held, turned on and off, manipulated, operated and used while shaving legs, arms, chest, and other body parts and a stable horizontally aligned form-fitted shaver base that provides protection for the shaver housing and encased components, for the shaving head assembly and the cutting blade assembly, and for different surface areas when the shaver is in mobile intermittent use and being placed down in varying locations.

### BACKGROUND

A rotary blade electric shaver, as known to be housed and configured with rotary shaver cutting blades at the head, or top, of the shaver housing, is difficult to hold when being used to shave hair on the legs, arms, chest, and other body parts and does not provide a convenient line of sight view of the on and off switch control while the shaver is in use, making the shaving of various body parts with a rotary blade shaver far more difficult than need be. The same housing and configuration fails to stabilize the shaver, fails to protect the cutting blades when a protective cap is not readily accessible, and fails to protect surface areas when the shaver is not in use and placed down on its front, back, or side. If a shaver is placed in or on a fixed-location stand or other fixed-location unit, the shaver becomes immobilized for use and stability is not assured. Fixed location stands and other fixed location units simply do not provide protection for a shaver, for its cutting blades, and for different surface areas when the shaver is in mobile intermittent use and placed down in varying locations.

### BRIEF SUMMARY

The problems set forth in the aforesaid background are resolved by an integrated rotary electric shaving unit for a rotary blade shaver that is mobile-friendly, with a shaver housing that is easily, comfortably, and more effectively held, turned on and off, manipulated, operated and used while shaving legs, arms, chest, and other body parts; clearly visible alternate on and off switch control; and a supportive and more stable horizontally aligned form-fitted shaver base that provides protection for the shaver housing and encased components, protection for the shaving head assembly and cutting blades, and protection for different surface areas when the shaver is in mobile intermittent use and being placed down in varying locations.

### BRIEF DESCRIPTION OF THE DRAWINGS

FIG. 1 is a side view of a rotary electric shaving unit showing an upper shaver housing (10), a lower shaver base (20), on and off switch control (30), and an electric power cord insert (40).

FIG. 2 is a cutaway side view of a rotary electric shaving unit showing a battery powered motor (50), a motorized gear assembly (60), a shaving head assembly (70), a cutting blade assembly (80), and non-slip scratch protective pads (90).

### DESCRIPTION AND BEST MODE OF IMPLEMENTATION

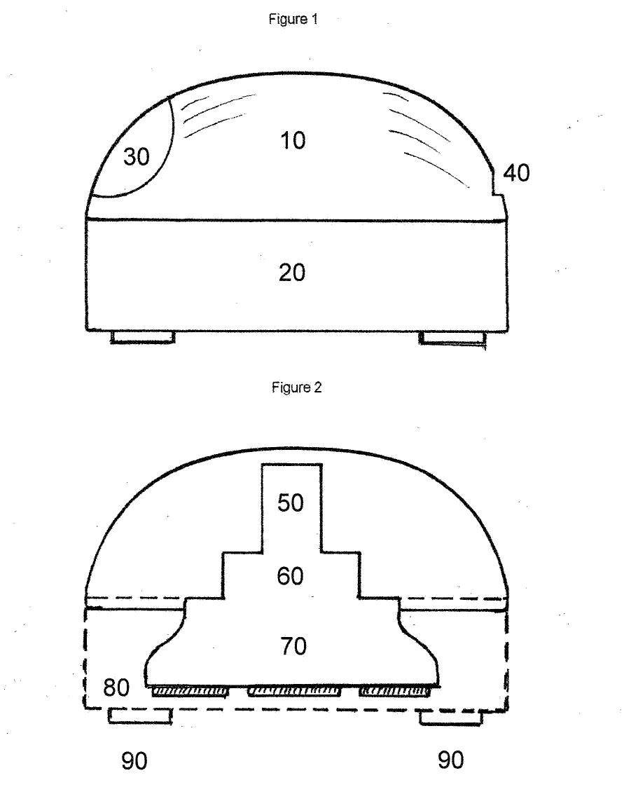

FIG. 1 is a side view of the rotary electric shaving unit and shows the two underlying parts of one unit, an upper shaver housing (10) and a lower shaver base (20).

FIG. 1 further shows that the shaver housing is shaped as an upper portion of a horizontal ellipse that is enclosed by a horizontal straight-line bottom; operates by alternate on and off switch control (30) at the upper front of the shaver housing on either side; and includes an electric power cord insert (40) at the lower back of the shaver housing for recharging batteries.

FIG. 2 is a cutaway side view of the rotary electric shaving unit and shows the shaver housing by solid lines. A battery powered motor (50) is encased within and centered at the top of the shaver housing; a motorized gear assembly (60) is encased within the shaver housing and vertically aligned below the motor; a shaving head assembly (70) is attached to and vertically aligned below the gear assembly and not encased; and a cutting blade assembly (80) is attached to and vertically aligned below the shaving head assembly and not encased.

FIG. 2 further shows the shaver base by dashed lines. The shaver base is enclosed by a horizontal straight-line bottom and by surrounding sides with an open top that is form-fitted for attachment to the shaver housing when the shaver is not in use and in mobile intermittent use. Non-slip scratch protective pads (90) are attached underneath and at the front and back of the shaver base.

Outer surfaces of the shaver housing and shaver base are templates for color, text, numerals, images, and graphics.

Operated with an expanded grasp on top of, over, and around the shaver housing and with clearly visible alternate on and off switch control, the shaver housing provides ease, comfort, and efficiency when held, turned on and off, manipulated, and used while shaving legs, arms, chest, and other body parts.

Attached when the shaver is not in use and when the shaver is in mobile intermittent use, the shaver base provides protection for the shaver housing and encased components, protection for the shaving head assembly and cutting blade assembly that are not encased in the shaver housing, and protection for different surface areas when the shaver is being placed down in varying locations.

The integrated rotary electric shaving unit described and shown provides ease, comfort, and efficiency in the shaver housing and stability, protection, and mobility in the shaver base.

The integrated rotary electric shaving unit described and shown allows the shaver to sit down in the shaver base and at the same time, in essence, stand on its head.

Shaver parts and supplies currently manufactured and sold can be used to accommodate the configuration of the rotary electric shaving unit described and shown with a rechargeable battery or batteries, circuit board, switches, and connections encased in the upper shaver housing, and with an electric power cord. Travel, grooming, cleaning, and other accessories can be included for manufacture and sale.

Modifications for AC, cell, solar, or other power sources and compatible components, to the alternate on and off switch control, to the power cord insert, and to the non-slip scratch protective pads are foreseen. Alternative configurations can be expected to show a charging light, a battery power indicator, a fourth or fifth cutting blade, the shaver base as a charging base, wet and dry capabilities, moisturizing apparatus, cleaning systems, and other amenities for an integrated mobile unit. Modifications and alternative configurations are considered herein to be subsumed within the scope and essence of the rotary electric shaving unit and the description, drawings, and claims set forth in this application.

A Drawing Sheet and an Abstract are set forth on separate pages and fully incorporated as though set forth herein.

1. A rotary electric shaving unit, comprising: an upper shaver housing with a lower shaver base.

2. Said upper shaver housing in claim 1, comprising: the shaver housing that is shaped as an upper portion of a horizontal ellipse enclosed by a horizontal straight-line bottom; alternate on and off switch control located on the shaver housing at its upper front on either side; an electric power cord insert located on the shaver housing at its lower back for rechargeable batteries; and further comprising a battery powered motor, a motorized gear assembly, a shaving head assembly, and a cutting blade assembly centered in the upper shaver housing and vertically aligned downward with the motor and the gear assembly encased within the shaver housing and on top of and connected to the shaving head assembly and the cutting blade assembly below that are attached to and not encased within the shaver housing.

3. Said lower shaver base in claim 1, comprising: the base that is enclosed by a horizontal straight-line bottom and by surrounding sides, open on top, horizontally aligned, and form-fitted as an attachment to the upper shaver housing; and with non-slip scratch protective pads underneath the bottom of the shaver base.

4. Outer surfaces of said upper shaver housing and said lower shaver base in claim 1, comprising: templates for color, text, numerals, images, and graphics.
